(19) United States
(12) Patent Application Publication
(10) Pub. No.: US 2013/0306284 A1
(43) Pub. Date: Nov. 21, 2013

(54) Heat Exchanger Panel And Method For Manufacturing Thereof

(71) Applicant: Pál Molnár, Balatonalmadi (HU)

(72) Inventor: Pál Molnár, Balatonalmadi (HU)

(21) Appl. No.: 13/982,319

(22) PCT Filed: Nov. 30, 2011
(86) PCT No.: PCT/HU2011/000117

§ 371 Date: Jul. 29, 2013

(30) Foreign Application Priority Data
Nov. 30, 2010 (HU) P 10 00641

(51) Int. Cl. F28F 3/00; B23P 15/26

(52) U.S. Cl. CPC F28F 3/00; B23P 15/26
USPC 165/168; 29/890.03

(57) ABSTRACT

The invention relates to a heat exchanger panel (10) preferably for heat exchange utilizing light energy, comprising a board (24) having plates parallel to each other, and partition walls (12) dividing the inner space between the plates into parallel channels (14), said partition walls (12) joining the plates and being of a same material as the plates, passages (18) in the partition walls (12), said passages enabling the flow of a heat exchanger medium between the neighbouring channels (14) and providing a flow path (20) for the medium, sealing units (16) covering openings at the ends of the channels (14) and joints (22) allowing the heat exchanger medium to enter into and exit from the panel (10). According to the invention, the sealing units (16) are made of a sealant which is thermal expansion compatible with the material of the board (24), the sealant being introduced into the ends of the channels (14). The invention also relates to a method for manufacturing the heat exchanger panel (10).

### TECHNICAL FIELD

The invention relates to a heat exchanger panel suitable for the accumulation and consumption of light energy, and to the manufacturing method thereof.

### BACKGROUND ART

The application of heat exchanger elements as solar collectors are increasingly widespread, but due to their strongly varying and relatively long (5 to 10 years) payback period depending on latitude, climatic conditions and the taxation and subsidies system of various countries, they are now primarily purchased by environmentally conscious people. The increasingly broader use of solar collectors will certainly reduce the detrimental effects of global warming. According to the data published by EurObserv'Er 2010, solar collectors were installed in 2009 on an area of more than 40.2 million sq.m in the world, of which on the territory of the EU 4.3 million sq.m was fitted with a power equivalent of more than 2800 MW, which corresponds in magnitude to the power of an average nuclear power plant. In light of this, it is an extremely important task to develop, manufacture and introduce to the market a collector type which is much cheaper than the current types, and therefore has a shorter payback period, which product offers a significant business profit to the consumers already in the short run, and hence gains increasing popularity, in addition to contributing to the further acceleration of the approx. 15% annual power increase of already installed solar collectors.

Approx. 26% of the Sun's total radiant energy arriving at the external boundary of the atmosphere is reflected to space, a further 23% is absorbed by the atmosphere, and hence about 51% of the solar energy of an intensity depending on the position of the Sun and the geographical position reaches the surface of the Earth.

About 3.25% of the solar energy arrives in the ultraviolet (UV) light range, 42.57% in the visible light (VL) range and 54.18% in the infrared (IR) range. On the external surface of the solar collector, in the walls of the collector board, and in the air or fluid between the walls, the various frequency rays behave differently, and depending on their frequencies, they are absorbed, passed through and reflected to different extents.

Multilayer polycarbonate boards with different thickness and structure made of parallel plates with partition walls perpendicular, or in some models oblique, to the plates and including parallelogram or triangle cross section cells and channels parallel to the axis of the board are used broadly now for example in the construction industry and for greenhouses.

Due to their extremely favourable physical characteristics, low specific mass, high mechanical strength, good light permeability and excellent heat insulation, as well as proven long life, they are especially suitable for covering and confining large inner spaces requiring intensive natural lighting.

The boards typically made with 2100 mm width, 6000 to 12000 mm length, 6, 8, 10, 16, 20 and 25 mm thickness, using 2 to 6 parallel or oblique plates of usually different thickness let through 50 to 80% of the energy of light reaching the surface of the board, depending on the number and thickness of the plates, but they practically reflect all the energy of the thermal infrared rays. Therefore, most of the solar energy arriving at the surface of the board reaches the inner space confined by polycarbonate plates, and by being absorbed in this space, it heats up the air in the enclosed space, but the board mostly prevents the radiation of thermal energy in the form of thermal infrared rays from the inner space, and the heat loss primarily occurs in the form of heat transmission on the surface of the panel exposed to the outer atmosphere.

If the cells of the multilayer polycarbonate board are filled up with water or other liquids suitable for absorbing light energy, for example, a mixture of water and ethylene glycol or a salt solution (e.g. an aqueous CaCl₂ solution) or an uncoloured or dark coloured mixture thereof, then in the liquid layer of 8 to 22 mm thickness inside the board, most of the energy of light passing through the external surface of the board is absorbed. The extent of absorption is influenced significantly in each frequency range and also in total by the composition and colour of the fluid.

When the boards are filled up with a fluid which is suitable for absorbing the infrared component of solar energy and for taking away the accumulated energy, in addition to the removal of solar energy absorbed in the fluid together with the fluid, expands the current fields of application of the multilayer polycarbonate board with further very useful practical applications which are very significant from an investment, energetic and environmental aspect.

A 2100 mm standard width polycarbonate board generally available from trade includes 210 to 500 parallel channels (risers) depending on the 10 to 25 mm board thickness. Many theoretical solutions are known for sealing the channels and providing inlets and outlets for the liquid at the trimmed ends of the board.

From among the numerous practical utilisation possibilities of multilayer polycarbonate board sealed at the ends of the channels and lending itself to being filled up with and circulating fluid, application as a solar collector is of crucial importance. The prime cost of collectors made in such a way is much lower than that of the collectors currently available, and its efficiency can be increased to a very high level.

For the heat exchanger liquid, in most cases only one inlet and one outlet joint is applied for each board, and to create the flow path there are openings in the partition walls, preferably on an alternating basis at the longitudinal ends of the partition walls, thereby preferably creating a labyrinth or serpentine type flow space.

In light of the demand detailed above, numerous theoretical design of, in many cases polycarbonate based, heat exchanger panels is known. They are described below, with special regard to the sealing structures.

In U.S. Pat. No. 5,645,045 a heat exchanger apparatus made of polycarbonate is described, in which so-called end caps are used for sealing. The heat exchanger has a serpentine type flow path. The document does not dwell on the method of securing the sealing end caps to the board.

U.S. Pat. No. 4,898,153 discloses a polycarbonate heat exchanger panel of similar flow space. In this invention sealing is again provided by end caps. U.S. Pat. No. 4,426,999 describes a polycarbonate heat exchanger, the sidewalls and sealing units of which are made of pre-fabricated polycarbonate elements, and they are assembled as separate components. DE 27 29 734 A1 and WO 91/04403 describe a heat exchanger with serpentine type flow space and end caps. None of the documents describe how the sealing units are attached to the board.

In U.S. Pat. No. 4,082,082, U.S. Pat. No. 4,114,597, U.S. Pat. No. 4,227,514, U.S. Pat. No. 4,239,035, US 2003/0131842 A1, U.S. Pat. No. 7,063,126 B1, U.S. Pat. No. 2008/0047544 A1, U.S. Pat. No. 7,431,030 B2, US 2009/0095282 A1, EP 2 105 682 A2, WO 2010/007548 A2 and HU 218 930 B, heat exchanger elements made of polycarbonate or a different plastic material are described. Heat exchanger elements having a serpentine type flow path are described in U.S. Pat. No. 4,085,728, U.S. Pat. No. 4,156,419, U.S. Pat. No. 4,252,103, U.S. Pat. No. 4,375,808, U.S. Pat. No. 4,473,064 and DE 27 09 801 A1. The solutions listed here generally comprise extremely costly heat exchanger elements manufactured with sealing walls.

It is a disadvantage of prior art solutions that they do not provide a solution for sealing the ends of the channels in an efficient, low cost, durable and pressure resistant way, and hence for the application of plastic, e.g. polycarbonate boards available from trade in the manufacturing of solar collectors. Polycarbonate has a high rigidity and a considerable thermal expansion coefficient which is multiple value than that of metals, e.g. 2.85 times higher than aluminium and 5.81 times higher than iron, as a result of which the sealing of the ends of the channels could not be solved by the solutions known so far in a way that the thermal fluctuations necessarily occurring in everyday use can be tolerated in the long run. A further disadvantage of prior art solutions is that they are usually very complicated and costly to manufacture. As a result, polycarbonate heat exchanger panels are not used broadly.

In light of the environmental and social requirements, prior art solutions and problems, the need has arisen to create a heat exchanger panel using a low cost, long-life, pre-manufactured plastic—preferably polycarbonate—board, with a sealing that ensures proper functioning in the long run.

### DESCRIPTION OF THE INVENTION

Thus, an object of the invention is to create a low cost heat exchanger panel and a manufacturing method for this heat exchanger panel, which are free of the disadvantages of prior art solutions, and which as a result of its design is suitable for the efficient accumulation of solar energy, by minimising the thermal currents reflected by the panel surface and the heat convection from the external surface, in addition to the losses arising in the form of heat transmission, in order to approach the theoretically achievable maximum efficiency.

The object of the development and the invention is to provide a panel, which, keeping the improving of efficiency in mind and in view of the different physical characteristics of solar radiation in each frequency range, utilises the energy content of each frequency range in a different way and converts this energy into radiations accumulated by the collector.

The objects of the invention are accomplished by a heat exchanger panel described in claim 1 and by a manufacturing method described in claim 18.

The heat exchanger panel comprises a transparent thermoplastic board having plates parallel to each other, and having partition walls dividing the inner space between the plates into parallel channels, said partition walls joining the plates and being of the same material as the plates. The heat exchanger panel furthermore comprises passages in the partition walls, said passages enabling the flow of a heat exchanger medium between the neighbouring channels and providing a flow path to the medium; sealing units closing the openings at the end of the channels in a way that a sealant being thermal expansion compatible with the material of the board is introduced into the ends of the channels; threaded joints allowing the heat exchanger medium to be introduced into and removed from the panel; surfaces preferably suitable for absorbing the visible components of light, returning the absorbed energy in the form of infrared radiations to the liquid space; and a heat insulation on the side opposite to the incident light.

### BRIEF DESCRIPTION OF DRAWINGS

Preferred embodiments of the invention will now be described by way of example with reference to drawings, in which

FIG. 1 is the cross-sectional view of a heat exchanger panel according to the invention, taken in parallel with the external plates, i.e. the surface of the panel,

FIG. 2A is a part-sectional view taken in parallel with the surface of the panel according to the invention using a sealing made of polycarbonate melt and an end cap,

FIG. 2B is a part-sectional view perpendicular to the surface of the panel shown in FIG. 2A,

FIG. 3A is a part-sectional view taken in parallel with the surface of the panel according to the invention, using a sealing made of polycarbonate melt, without an end cap,

FIG. 3B is a part-sectional view perpendicular to the surface of the panel shown in FIG. 3A, without an end cap,

FIG. 4A is a part-sectional view taken in parallel with the surface of the panel according to the invention, using a sealing made of polycarbonate melt, with fibreglass reinforcement and an end cap,

FIG. 4B is a part-sectional view perpendicular to the surface of the panel shown in FIG. 4A,

FIG. 5A is a part-sectional view taken in parallel with the surface of the panel according to the invention, using a sealing made of polycarbonate melt, with fibreglass reinforcement and without an end cap,

FIG. 5B is a part-sectional view perpendicular to the surface of the panel shown in FIG. 5A,

FIG. 6A is a part-sectional view taken in parallel with the surface of the panel according to the invention, with a polyurethane based sealant cured after setting-in after application and an end cap,

FIG. 6B is a part-sectional view perpendicular to the surface of the panel shown in FIG. 6A,

FIG. 7A is a part-sectional view taken in parallel with the surface of the panel according to the invention, with a polyurethane based sealant cured after setting-in and without an end cap,

FIG. 7B is a part-sectional view perpendicular to the surface of the panel shown in 7A,

FIG. 8A is a part-sectional view taken in parallel with the surface of the panel according to the invention, sealed by plugs made of flexible material at the cell ends,

FIG. 8B is a part-sectional view perpendicular to the surface of the panel shown in FIG. 8A,

FIG. 9 is a part-sectional view of the panel according to the invention and directly fitted on a roofing,

FIG. 10 is a part-sectional view of the installation of the panel according to the invention and fitted for a further advantageous purpose, i.e. sandwich panel thermal insulation,

FIG. 11 is a part-sectional view of installing a panel made of a three-layer board according to the invention,

FIG. 12 is a part-sectional view of the collector and its installation when made of two double-layer boards, which represent an especially advantageous embodiment,

FIGS. 13A-C are part-sectional views perpendicular to the surface of a panel when made of two double-layer boards according to the invention, which views show the manufacturing phases of the panel,

FIG. 14 is a part-sectional view of the collector and its installation when made of two double-layer boards representing an especially advantageous embodiment, with the illustration of the joint,

FIG. 15 is the sectional view taken in a crosswise direction of the apparatus serving for producing the panels according to the invention, and

FIG. 16 is a cross-sectional view of the apparatus shown in FIG. 15, taken in a longitudinal direction.

### MODES FOR CARRYING OUT THE INVENTION

Our object when developing the heat exchanger panel according to the invention was, by making use of the multilayer polycarbonate boards available from trade and by sealing its channels in a way that these sealing points are reliable in the long run, to provide a durable and extremely high efficiency heat exchanger panel, which has a much lower prime cost than the heat exchanger panels currently available from trade.

In making the sealing, the most important requirement is that the sealing units have a thermal expansion compatible joint with the rest of the panel. The various daily repeated expansion and shrinkage tendencies of the sealant material in comparison with the material of the board lead to contact failure between the sealing units and the board, panel defect, loss of the panel's pressure resistance and then total damage.

In the heat exchanger panel according to the invention, in order to prevent damage caused by the differences of thermal expansion, heat expansion compatible sealing materials are applied, and a material identical with that of the board is especially preferred, as a result of which a stress stemming from the different thermal expansions of the board and the sealant material does not arise in the heat exchanger panel, because such a stress would lead to the fatigue and damage of the materials, i.e. the sealing will be resistant on a prolonged basis to thermal fluctuations.

We mean thermal expansion compatible sealing material according to the invention all materials which have such a thermal expansion coefficient and Young's modulus to ensure that dimensional changes arising as a result of temperature fluctuations during operation, i.e. a distortion stemming from thermal expansion are flexible in all materials assembled in the panel, in all points of the panel, without modifying the material structure created by the assembly or the contact and sealing created by filling up the volume.

A sealing produced from a material identical with that of the board without the use of any further foreign adhesive, sealing agent, etc. is the most compatible solution theoretically, because in this case the thermal expansion coefficients of all the applied materials are identical, consequently no stresses may arise within the panel as a result of temperature changes.

Theoretically, sealants e.g. PUR-based sealants which are especially flexible after curing can be applied, especially by the installation of fibreglass suitable for withstanding the stress, but in these cases it could be a problem that the sealant has 4 to 8 times larger thermal expansion than that of polycarbonate, which leads to the fatigue and splitting of the surface plates of the board.

The heat exchanger panel according to the invention may have many embodiments, of which only a few will be described below.

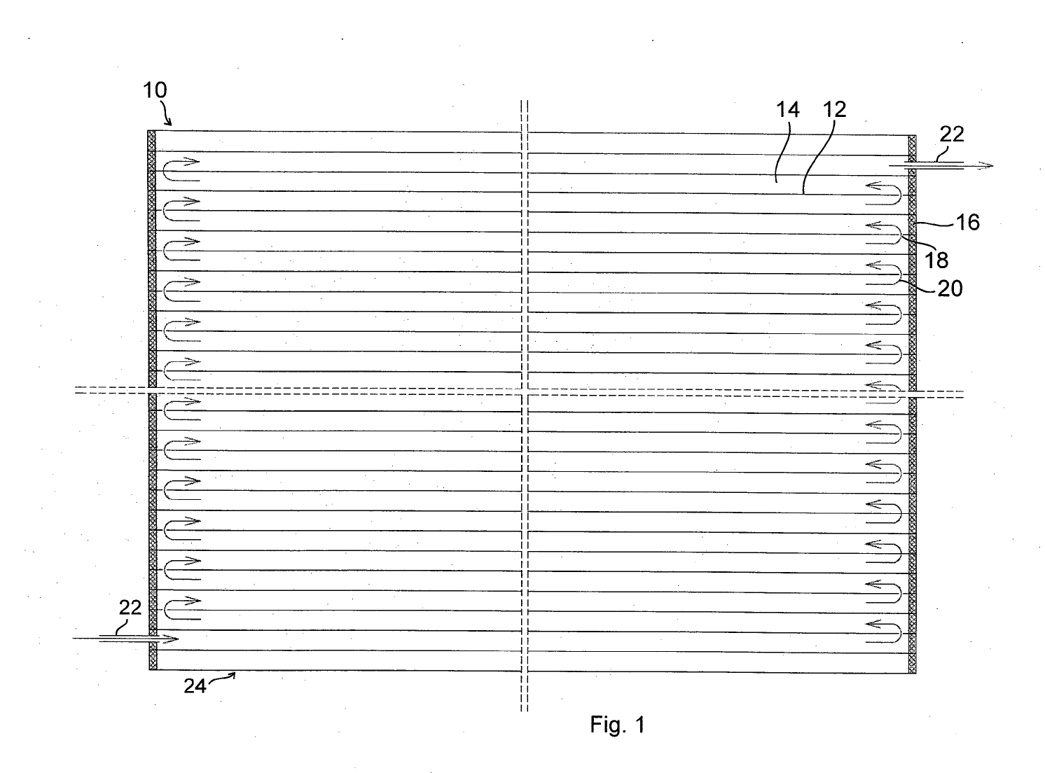

FIG. 1 shows the cross-sectional view of a preferred embodiment of the heat exchanger panel 10. The heat exchanger panel 10 is divided into parallel channels 14 by the partition walls 12, and the ends of the channels 14 are covered by the sealing units 16. The flow space of the heat exchanger panel 10 is created by the passages 18, in which the flow path of the heat exchanger medium 20 is indicated by arrows.

The joints 22 for the liquid space of the panel 10 represent extra components, consequently an extra production cost and for the user an extra installation cost. It is advisable therefore to reduce the number of these parts to the theoretical minimum, i.e. only two per board, consequently to one joint which introduces the heat exchanger medium to the flow path 20, and a joint 22 which removes the medium therefrom, as shown in FIG. 1.

To make sure that the lowest possible number of joints 22 is applied, prior to the sealing of channels 14, in the way shown in FIG. 1, passages 18 are created in the partition walls 12, with the diameter of the passages being about one-half of the fluid space thickness perpendicular to the board (approx. 4 to 5 mm dia.) with the number of passages depending on the length of the channels in view of the permitted flow resistance, and with the passages being preferably next to the sealing units 16 which cover the ends of the channels 14, at a distance of 2 to 3 mm from them and from each other. In each partition wall 12 between two channels 14 one or several passages 18 are made side by side, alternatingly at one or the other end of the board 24. Consequently, the passages 18 are created next to the sealing units 16, alternatingly at the longitudinal ends of the partition walls 12 between the neighbouring channels 14, by setting up a labyrinth or serpentine type flow path 20.

In this way, the medium entering at one of the joints 22 proceeds along all the channels 14 and then reaches the other joint 22.

The slotted lines shown in the figure indicate that the heat exchanger panel 10 may consist of an arbitrary number and arbitrary length of channels 14.

FIG. 1 also shows the operating principle of the heat exchanger panel 10 based on the use of preferably transparent thermoplastic material, with the especially preferable solution being the application of polycarbonate board 24. The medium enters into the serpentine type flow path 20 designed as described above through one of the joints 22 of the board 24 located preferably with a horizontal channel direction, proceeds continuously along the serpentine type path, proceeds along all the channels one by one, and it is continuously heated up as a result of the light energy absorbed by the medium, and then the medium exits through the other joint 22 to a system designed to collect the heated up medium. Horizontal installation is required, because if the cells were installed in a vertical position, the gases would accumulate at the top of the cells after escaping from the heated up heat exchanger fluid, and thereby gas plugs blocking the flow could emerge.

The temperature of outlet medium can be regulated by changing the flow rate of the medium. This is because the temperature of the surface of the board 24 gradually increases along the flow path 20, and therefore heat transmission to the external space also increases in the hotter parts of the board 24. This is much more favourable than the situation when the whole external surface of the collector reaches the temperature of the generated hot liquid, and this solution results in a further improvement of efficiency. According to the experimental measurements and control calculations, vis-à-vis a collector of nearly uniform temperature on the whole surface, the panel can utilise a 1 to 2% higher share of the total radiated energy in the case of 20° C. external temperature and 50° C. outlet liquid temperature, which efficiency difference increases further with the reduction of external temperature or with the rising of temperature gradient.

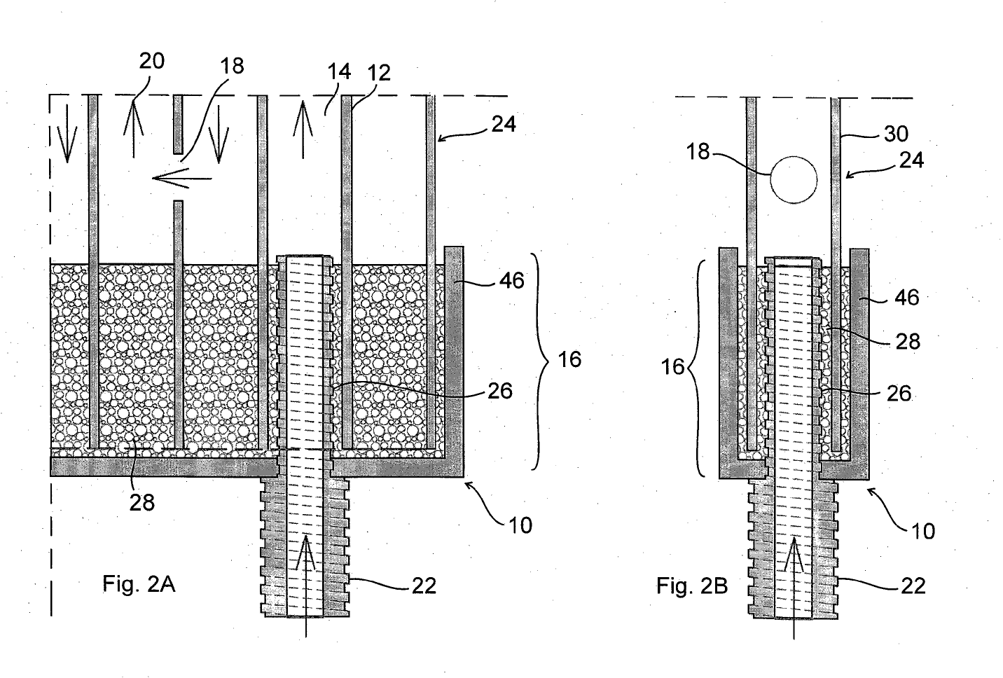

FIG. 2A shows a preferred embodiment of the sealing unit 16 of the heat exchanger panel 10 in cross-sectional view. The figure shows by arrows the flow path 20 created with the partition walls 12 and passages 18 of the channels 14. The joint 22 is also shown, through which the heat exchanger fluid reaches the flow path 20 or can be removed therefrom. The joint 22 is linked to the sealing unit 16 preferably by the metric threads 26, and the said sealing unit in this embodiment is made of especially preferable polycarbonate sealant 28. FIG. 26 shows another sectional view of the heat exchanger panel 10, which section is perpendicular to the section shown in FIG. 2A. This section depicts the plates 30 bordering the board 24, and the partition walls 12 are joined to the said plates. FIG. 2B shows the circular passage 18 of this embodiment. FIG. 2B also shows the attachment of joint 22 to the board 24 with the metric threads 26, which are driven into the polycarbonate sealant 28 representing the sealing unit 16. If the sealing units 16 are made of the polycarbonate sealant 28, the disadvantages stemming from the different thermal expansions of the materials used can be avoided. For this, preferably when sealing the ends of the channels 14, the temperature of the board 24 and that of the polycarbonate sealant 28 only differ by a few degrees. This is because in this case through the parallel cooling of the board 24 and the polycarbonate sealant 28, the emerging of stresses during the sealing process can be avoided.

In the embodiment shown in FIGS. 2A and 2B, the longitudinal U-shaped tool 46 used for introducing the polycarbonate sealant 28 into the ends of channels 14 is not removed after making the sealing unit 16, but it becomes a part thereof, and will function as a protecting end cap.

Such a preferable embodiment of the heat exchanger panel 10 is shown in the sectional views 3A and 3B, which is different from the embodiments presented in FIGS. 2A and 2B in that the U-shaped tool 46 is removed after creating the sealing units 16.

In the course of making the sealing operation with the polycarbonate sealant 28, the arbitrary end to be sealed off at the multilayer polycarbonate board 24 which even has a full production width of 2100 mm is pre-heated in an approximate length of 1 m to a temperature gradually increasing towards the end. The open end of the board 24 is placed into a metal, preferably aluminium U-shaped tool 46 which is closed at the two ends, but open at the top, is approx. 20 mm longer than the width of the board, and has a depth of 15 to 20 mm, with a suitable space to receive the polycarbonate sealant 28. The tool 46 holds the polycarbonate sealant 28 which is heated to above the plastic yield point (250 to 270° C.). The still rigid board 24, the end of which is heated up to a temperature (180 to 200° C.) approaching the vitrification limit, is placed into the tool 46 and it is pressed into the few mm thick polycarbonate layer 24 heated to above the plastic yield point. To prevent the oxidisation of the polycarbonate sealant 28 and thereby an unfavourable change in its mechanical characteristics, preferably CO₂ or N₂ shielding gas is applied during the process. During the cool-off, between the surface of the board 24 material in contact with the polycarbonate sealant 28 and the polycarbonate sealant 28 introduced into the ends of the channels 14, a joint of sufficient strength practically which is pressure resistant up to 12 bars in accordance with measurements is established as a result of the melting of the material of board 24 and the polycarbonate sealant 28 used for the sealing. In our experience, such an internal pressure is withstood also by the thinner than 1 mm external surface of the board 24. The lifetime of the sealing unit 16 so created according to the invention is practically identical with that of the board 24.

The U-shaped tool 46 is an auxiliary tool used for making the sealing unit 16. After the making of the sealing unit 16, it can be arbitrarily removed from or left on the heat exchanger panel 10. If it is left on the panel 10, it is advisable to make sure that the material of the U-shaped tool 46 is also thermal expansion compatible with the material of the board 24.

In the case of the polycarbonate board 24 of 2100 mm width, the ribbon shaped body made of a polycarbonate sealant 28 applied mostly in granulate form and heated to approx. 250 to 270° C. in the U-shaped tool 46 of 2120 mm length would shrink theoretically in the longitudinal direction by approx. 30 mm while it cools to room temperature. In practice, due to the adhesion of the polycarbonate sealant 28 to the U-shaped tool 46 used in heating up and because of the gradual cooling of the complete cross section, only about one-half of the theoretical contraction can be experienced. However, such a change in shape is sufficient for tensile stresses based on the shrinkage to cause cracks in the sealing unit 16 made of the solidified polycarbonate sealant 28 and generally also in the external surfaces of the board 24. These cracks start with a width of 1 to 2 mm, are parallel with the partition wall 12 of the channels 14, run crosswise and penetrate to a depth of 5 to 10 cm from the end of the heat exchanger panel 10, depending on the thickness of the board 24 and its cooling rate, approximately at each 30 to 60 cm. This damage arises, if the room temperature board 24 is pressed into the melted polycarbonate sealant 28.

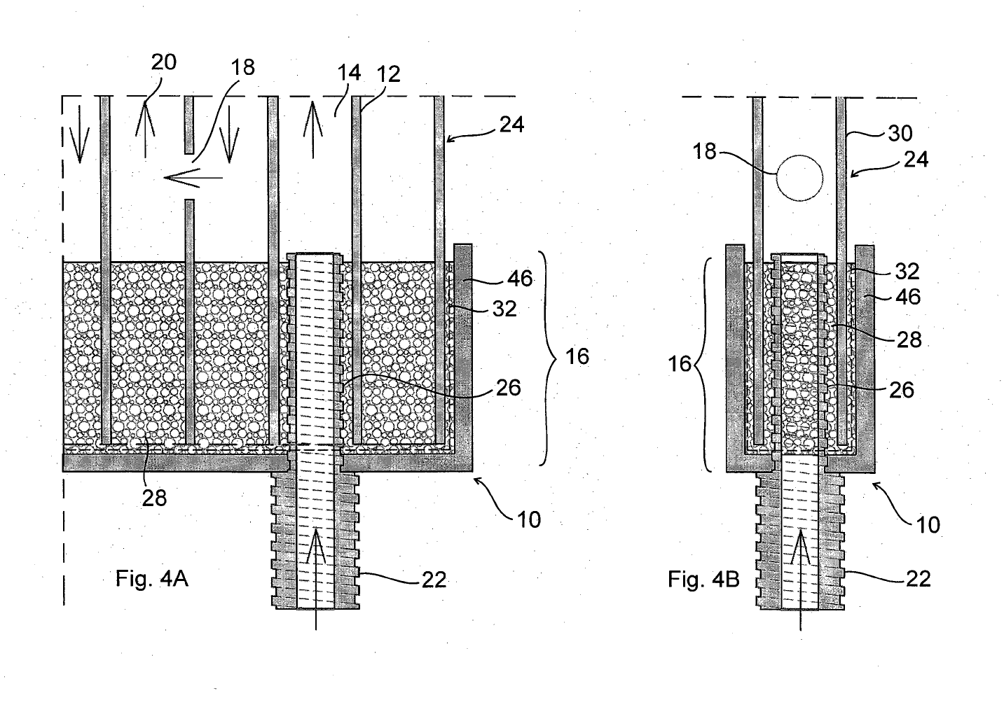

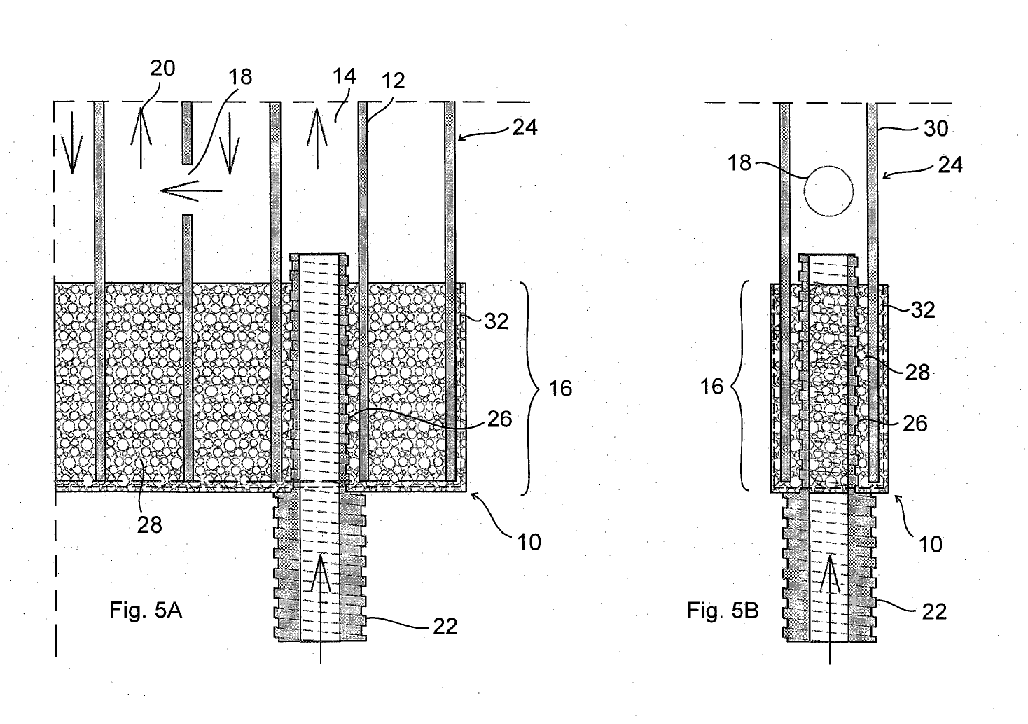

At the ends of the board 24, the shrinkage caused damage of polycarbonate sealing unit 16 made of the polycarbonate sealant 28 can be prevented successfully by installing the tensile stress resistant fibreglass 32 as illustrated in FIGS. 4A and 4B. Consequently, the sealing units 16 can be reinforced preferably by the fibreglass 32 fitted into the sealant. In the embodiment shown in FIGS. 4A and 4B, where the sealing is reinforced with the fibreglass 32, the U-shaped tool 46 has not been removed, while in the case of the embodiment shown in FIGS. 5A and 5B, it has been removed after creating the sealing unit 16. However, all by itself this does not eliminate fully the problems stemming from shrinkage, because the polycarbonate sealant 28 considerably shrinking while cooling from 240° C. to room temperature, induces substantial inner stresses in the room temperature board 24 pressed into it, and this causes a significant deterioration of the mechanical and technical characteristics of the board 24, thereby leading to a shorter lifetime.

In order to avoid the stresses arising in board 24, the polycarbonate board 24 is to be heated up close to the possible maximum temperature of 200° C. at which it still retains its mechanical strength so that as a result of the lower temperature difference and after the assembly, during a simultaneous cooling of nearly identical extent, the shrinking of the board 24 and the polycarbonate sealant 28 used for the sealing unit 16 can take place with a minimal difference.

The subsequent installation of threaded stubs serving as the inlet and outlet joints 22 does not only represent an extra work load, but also a crucial error source because of the thin layers, even if the work is carried out with a high precision and carefulness. When the approx. 10 mm thick solidified polycarbonate sealant 28 is applied at the ends of the channels 14, and when drilling and thread cutting to install the approx. 6 to 8 mm thick threaded piece, the remaining stiff polycarbonate sealant layer 28 of 1 to 2 mm thickness can be easily damaged. The threaded piece will only seal appropriately if a well-dimensioned Teflon sealing is used, but if too much sealing is applied to the thread, it may burst the board open during installation. This problem is eliminated by the solution in which through a bore made in the empty U-shaped tool 46, the connection piece with a threaded end outside the U-profile is pushed into the melt space. One end of the threaded piece made of brass or acid-resistant steel has 6 to 7 mm diameter and at the other end a ⅜ inch thread for example is connected to the feeding and collecting pipeline system. The connection piece 22 protrudes inside the U-shaped tool 46 so that as shown in FIG. 2, after the filling in of the polycarbonate sealant 28, the end of the thread is located 2 to 3 mm higher. After the melting of the polycarbonate sealant 28 and then the pressing in of the board 24, the material of the board 24 and the material of the sealing unit 16 comprising the outlet joint 22 cool down together, and therefore the connection between the inlet metal joint 22 and its polycarbonate environment caters for perfect sealing and strength. The polycarbonate has a much higher thermal expansion than the linear thermal expansion of the installed joint 22 made of any metal, and in the course of cooling it is simply shrunk on the metal joint 22, which results a better and stronger solution than any subsequent installation and fixing.

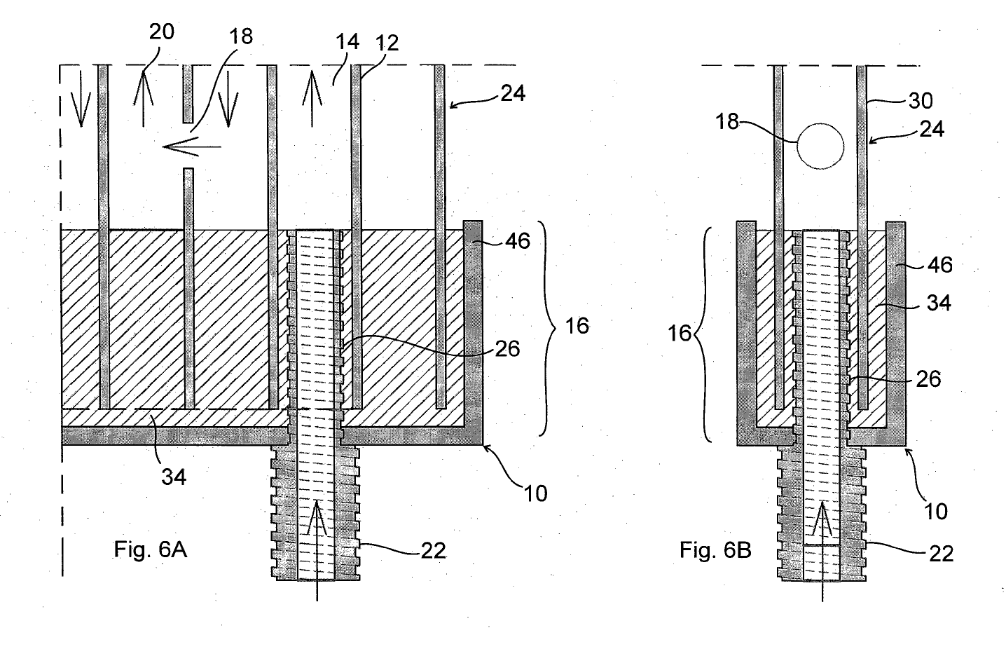

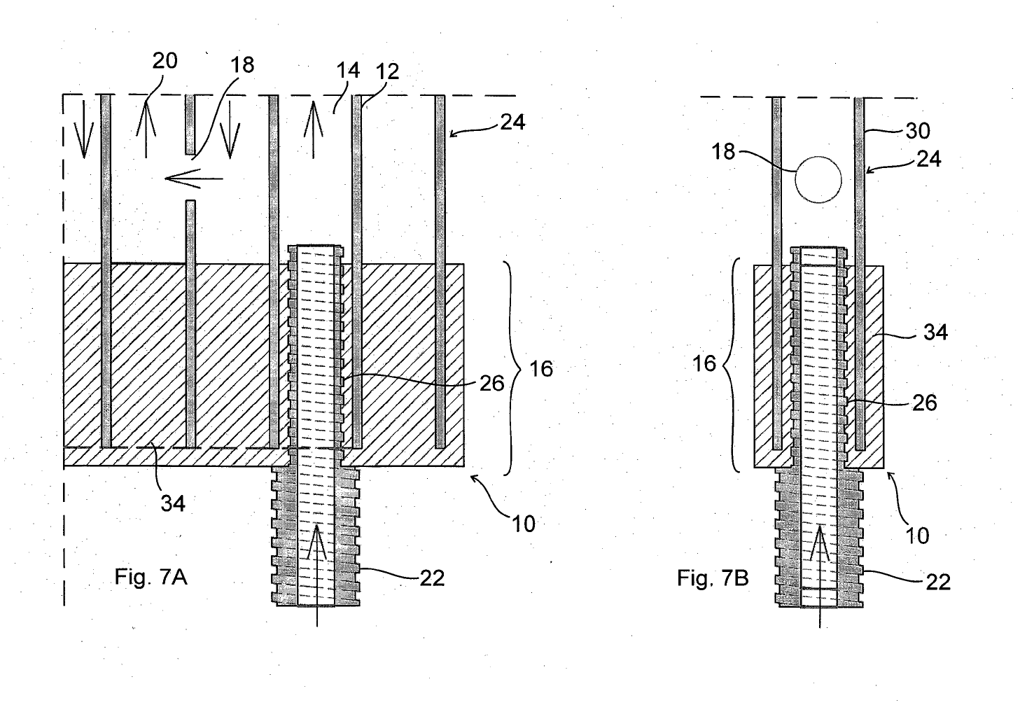

FIGS. 6A and 6B show a further preferred embodiment of the sealing unit 16 of the heat exchanger panel 10, in two perpendicular sectional drawings. These figures depict a very similar embodiment to that presented in FIGS. 2A and 2B, and the only difference is that in this case the sealing units 16 are made for example of a polyurethane (PUR) based sealant 34 introduced into the ends of the channels 14. Contrary to the embodiment shown in FIGS. 6A and 6B, in the embodiment shown in FIGS. 7A and 7B, the U-shaped tool 46 has been removed after the forming of the sealing unit 16. Depending on the thickness of the board 24, the channels 14 are filled up in a length of 5 to 30 mm with the sealant 34 based for example on PUR, which is preferably a sealant used broadly in the vehicle industry and which results after filling in and curing a flexible rubber-like sealing.

The U-shaped tool 46 is filled up with the appropriate PUR-based sealant 34, preferably to a level approx. 3 to 5 mm lower than the top edge, taking into consideration the volume increase during the curing process and the volume of partition walls 12 pressed into the PUR-based sealant 34. Next, it is pressed on the end of the board 24, and then stored in a vertical position for the curing time.

In connection with this method, a problem to be solved arises, mainly that the linear thermal expansion coefficient of the PUR-based sealants 34 is approx. six times as high according to the manufacturers' data than that of the polycarbonate board 24, and therefore especially in the case of thicker boards, the sealing unit 16 which expands much faster during the heat-up exerts significant stress perpendicularly on the surface of the board 24, and hence it may be cleaved between the partition walls of the channels 14. Subsequently, any joint for example a threaded joint 22 can be fitted into the cured flexible sealing without any problem, with the appropriate strength and water tightly. Just like in the case of the polycarbonate-based sealing, the connection piece can be fitted with a temporary fixing or with an appropriate positioning in the U-shaped unit even before being filled up with the sealant, and hence the sealant swelling during the curing process is pressed against the connection piece on the one hand, and it is forced into the end of the cell on the other.

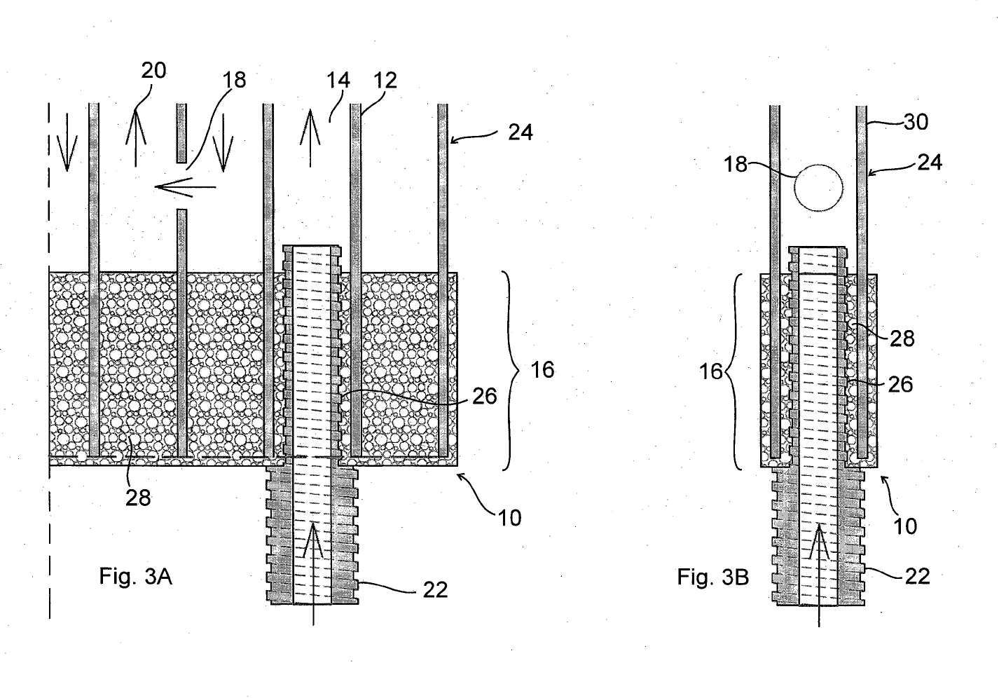

The stress resulting from the larger thermal expansion of the PUR-based sealant 34 acting perpendicular to the surface of the board 24 can be compensated by an appropriately dimensioned and sufficiently rigid metal or plastic U-shaped tool 46 which is not removed subsequently, i.e. the U-shaped tool 46 used in the formation of the sealing units 16 can be left on the heat exchanger panel 10. The strength and the resistance of the heat exchanger panel 10 against stresses caused by temperature changes can be further improved, if a shorter U-shaped fibreglass 32 folded up to the same level as the filled up sealant is placed into the U-shaped tool 46 of appropriately selected size, which is closed at the two ends and has an inner size approx. 2 to 3 mm larger than the thickness of the board 24, in a way similar to the configuration shown in FIGS. 3A and 3B, respectively. Therefore, even in this embodiment, the sealing units 16 can be reinforced by the fibreglass 32 inserted into the sealant. Preferably, the U-shaped tool 46 is filled up with the sealant after the insertion of the fibreglass 32.

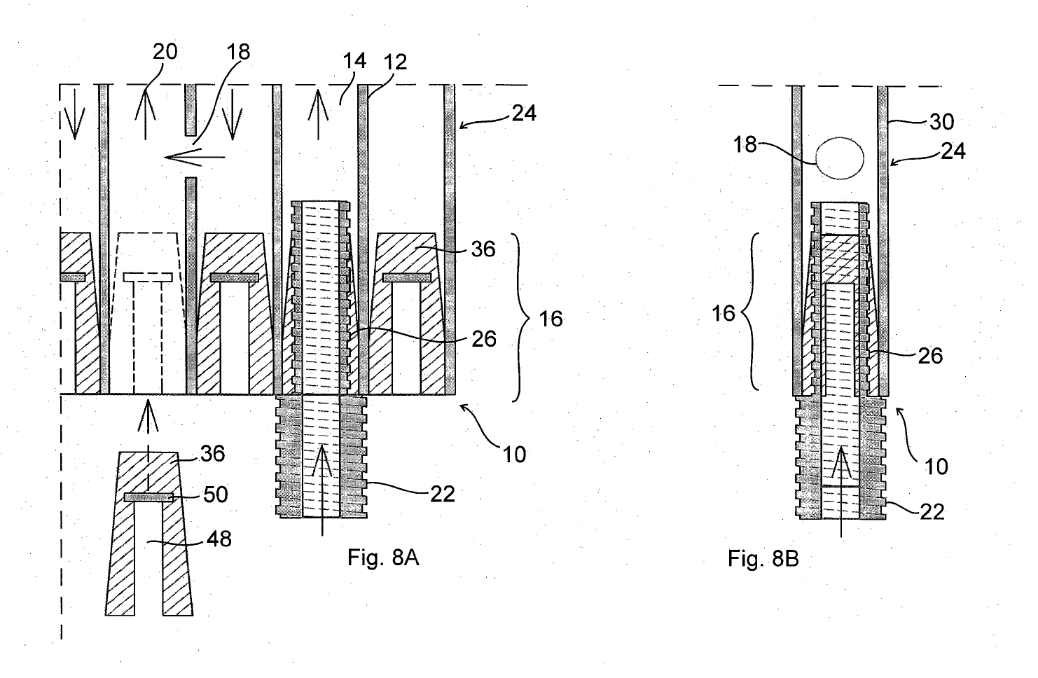

FIGS. 8A and 8B show a further preferred embodiment of the sealing unit 16 of the heat exchanger panel 10, in two perpendicular cross-sectional views. In this embodiment, the sealing units 16 are designed as plugs 36 which are made of a flexible material and placed into the ends of the channels 14. Preferably, the plugs 36 are made of rubber or silicone, they are of a truncated pyramid shape, and they have a blind hole 48 facilitating the insertion of the plugs 36, so that they can be appropriately pressed into the ends of the channels 14. Again, to facilitate this process, the plugs 36 can be preferably reinforced with a pressure distributor metal insert 50, designed to prevent the tool used for the insertion of the plugs 36 from puncturing the plugs 36. Consequently, the ends of the channels 14 are sealed separately one by one, using pieces of a suitable composition, manufactured by injection moulding by way of example, pressed in as the plug 36 and getting stuck in the channel 14. Preferably, also in this embodiment the number of the joints 22 is maximised to two, because applying a large number of joints 22 is uneconomic, and each plug 36 fitted with the joint 22 represents a new source of error.

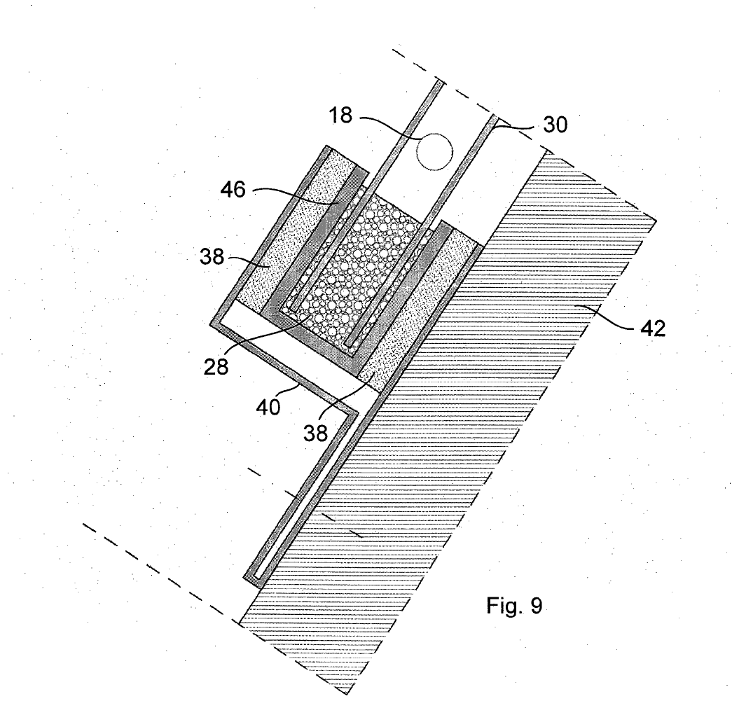

FIG. 9. shows one of the possible installation methods of the heat exchanger panel 10 onto a roofing 42. The heat exchanger panel 10 embedded into a hard, but flexible foam 38 is placed into a zinc plated and painted preferably metal piece 40 designed for this purpose, as shown in the figure. In the arrangement shown in the figure, such a heat exchanger panel 10 is featured, which is mounted with the U-shaped tool 46, and hence it has not been removed from the panel 10 after the formation of the sealing units 16.

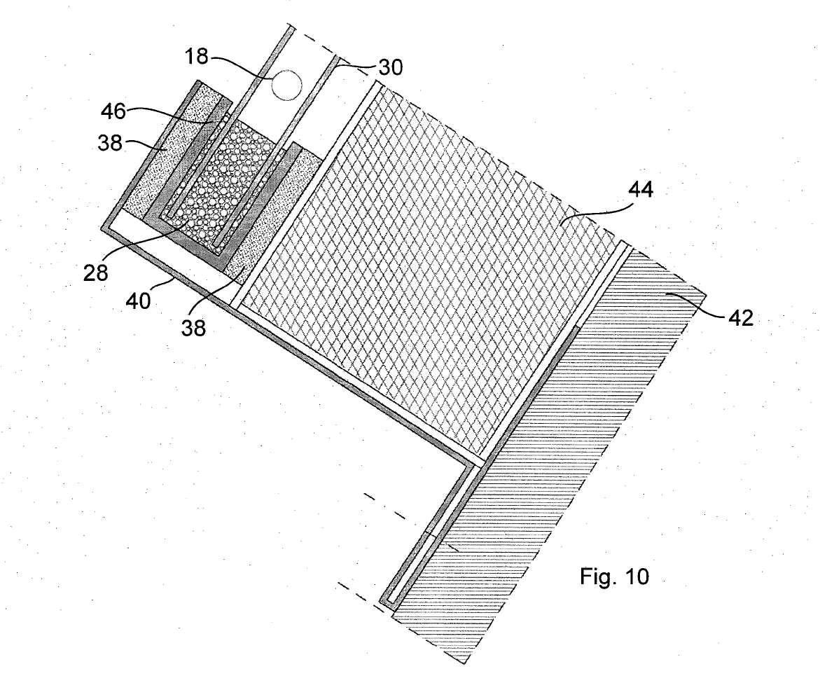

FIG. 10 shows a further possible installation method of the heat exchanger panel 10. At least along one part of the external surface of one of the plates 30, preferably a heat insulating material 44 is arranged in a way so as to prevent aeration. In the embodiment shown in the figure, the dark colour thermal insulating material 44 is located opposite to the incident light side of the heat exchanger panel 10, and this said thermal insulating material is preferably made of sandwich panel. Most of the visible light coming through the plates 30 of the heat exchanger panel 10 and the heat exchanger medium is absorbed on the top surface of the dark surface thermal insulating material 44; according to measurements this represents, depending on the applied type of panel, about 25 to 30% of the radiation energy arriving at the external surface of the panel 10. The absorbed light heats up the upper surface of the thermal insulating material 44 below the panel 10. The convective heat flow initiating from the heated up top surface is unable to remove the energy through the heat insulating material, and therefore the absorbed energy is only able to escape from the surface of the thermal insulating material 44 outwards, in the direction of panel 10, in the form of infrared beams and through heat transfer between the contacting metal and the polycarbonate surfaces, and therefore they necessarily pass through the plates 30 of the panel 10 and also through the heat exchanger medium between them, and depending on their frequencies, when proceeding through a layer, most of them is absorbed and results in a further heat-up of the fluid.

In this arrangement, therefore, the dark surface thermal insulating material 44 located below the panel 10 is not only and not primarily designed to prevent or reduce the heat loss of the panel 10, but it is also aimed at increasing the efficiency of the heat exchanger panel 10.

From the embodiment shown in the figure, the thermal insulating material 44 can be omitted, if the heat exchanger panel 10 is fitted on a plate covered roof heat insulated by an already existing sandwich panel or in a different way. In this case the piece 40 on the one hand secures the heat exchanger panel 10 to the already installed thermal insulating material underneath, and on the other it also provides an edge, consequently this version can be fitted also on an insulated roof. The length of the piece 40 is dimensioned in view of the expansion and shrinkage due to thermal expansion and in view of the movements stemming therefrom. The installed foam 38, which is by way of example polyfoam or other expanded (closed cell) foam type of material, prevents undesired heat exchange also by preventing the aeration of the air gap between the panel 10 and the heat insulated surface underneath, which is by way of example the external side of the thermal insulating material 44.

The metal piece 40 framing the heat exchanger panel 10 can be fixed by bolts to the roofing 42, subject to the material and design of the roofing 42. At the top end of the panel 10, preferably a frost resistant sealant is fitted between the panel and the roofing, to prevent an eventual water ingress from the top between the panel 10 and the thermal insulating material 44, because the said water ingress would lead to reflection and evaporation, thereby deteriorating the efficiency of the panel 10.

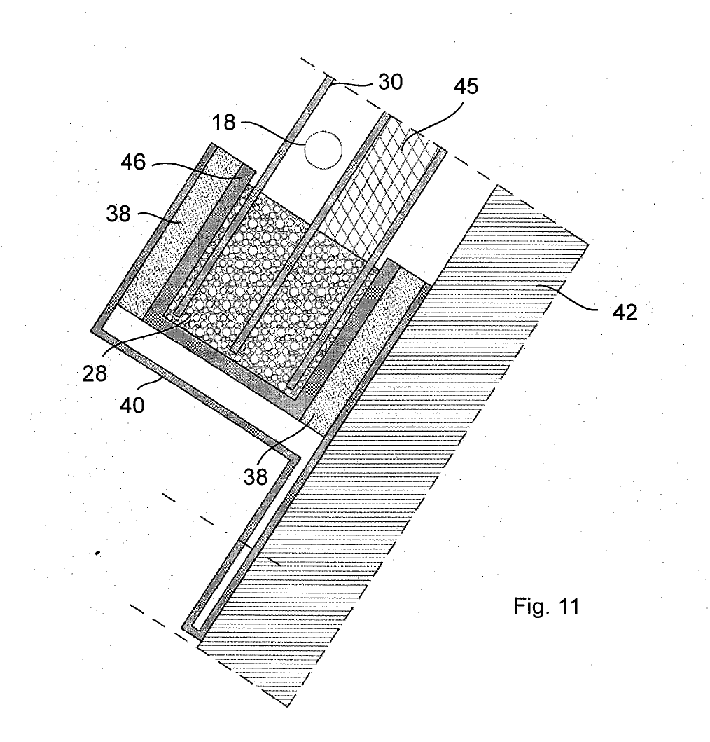

FIG. 11 shows a further embodiment of the heat exchanger panel 10, with an installation method similar to that shown in FIG. 9. In this embodiment of the panel 10, such a polycarbonate board 24 is applied, which has preferably more than two plates 30, and accordingly comprises at least one further inner space. In the embodiment shown in FIG. 11, a board having three plates 30 is shown. In this embodiment, in the inner space between one of the plate pairs the flow path 20 is created as described above, and it has the joints 22 serving for the inlet and outlet of the medium, while a thermal insulating material 45, preferably a polyurethane foam solidifying in channels 14 after installation, is introduced into the channels 14 of the further second inner space in a way that the inner space is at least partly filled up. Preferably, the thermal insulating material 45 can be introduced prior to the finishing of the sealing units 16 in a way preventing aeration into the inside of channels of the lower space closer to the roofing.

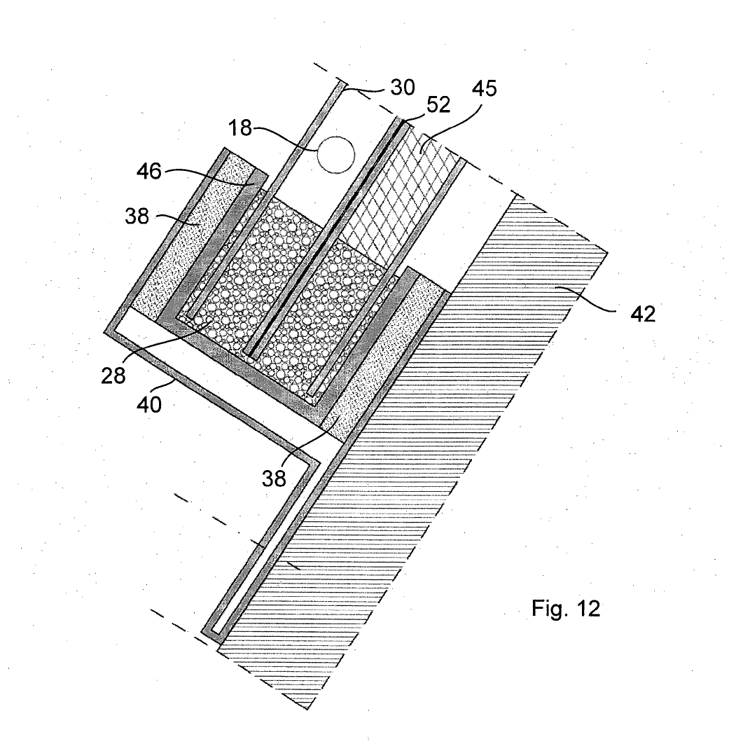

FIG. 12 shows the structure and installation method similar to that of FIG. 9 of a further embodiment of the heat exchanger panel 10. The embodiment according to FIG. 12 is different from the embodiment shown in FIG. 11 in that two double layer polycarbonate boards 24 are used, of which on the fluid space side top surface of the lower board, a light absorbing, preferably dark colouring 52 is used, and it is especially preferred to be painted black. Between the layers of the lower board, in the cells either before or after assembly, a thermal insulating material (for example, polyfoam or PUR-foam) is fitted. The two boards are attached to each other by the polycarbonate melt layer also serving as the sealing of the top board, again preferably applied together with fibreglass.

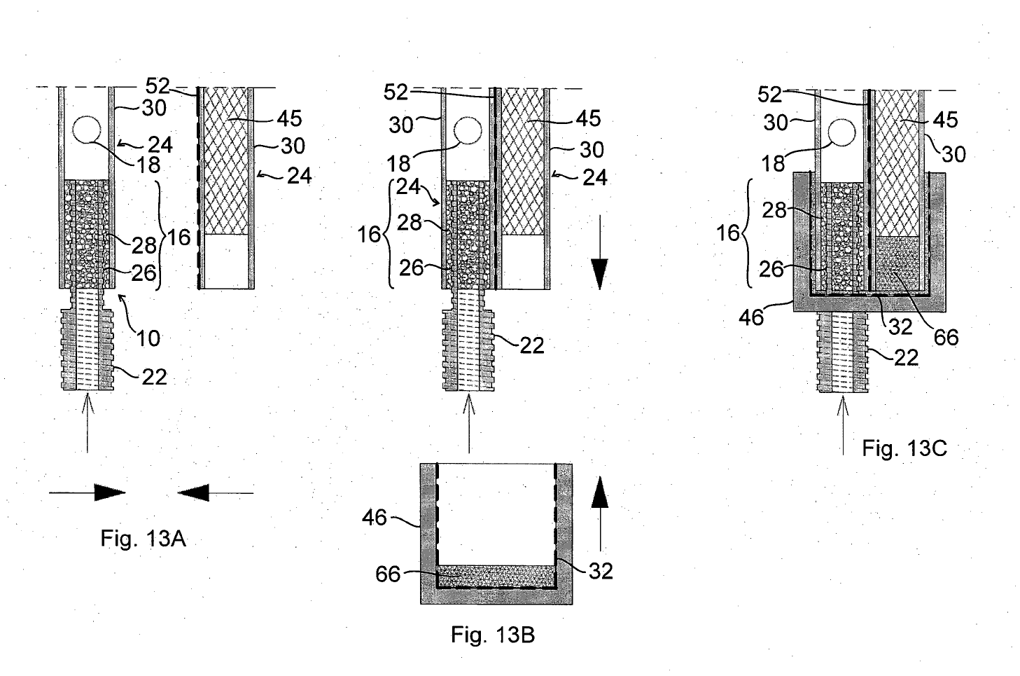

FIGS. 13A-C show the assembly steps of a further very advantageous embodiment of the heat exchanger panel 10. Also in this panel 10, two double layer polycarbonate boards 24 are assembled. In the first step, as shown in FIG. 13A, one of the boards 24 is made, and this is an embodiment of the heat insulating panel 10 reinforced with polycarbonate sealant 28 and fibreglass 32. In this step, the channels 14 of the other board 24, one surface of which to be assembled with board 24 has a dark colouring 52, is filled up with the thermal insulating material 45 in a way that at both ends of the channel 14 a 5 to 10 mm section of the channels 14 remains unfilled. After this, in the second step, as shown in FIG. 13B, the two boards 24 attached provisionally to each other are pressed into the 2 to 3 mm thick PUR-based sealant layer 66 pre-applied in the U-shaped polycarbonate tool 46 which has an inner base size 1 to 3 mm larger than the combined thickness of the two boards 24. After curing, the PUR-based sealant 66 seals with a vapour and air barrier the channels 14 of the board 24 filled up with the thermal insulating material 45, and therefore they will provide proper heat insulation on a prolonged basis, fix the two boards 24 to each other and together with the U-shaped tool 46 remaining on the panel 10 ensure a mechanical protection for the sealing unit 16 of the fluid space. FIG. 13C depicts the panel 10 which has been made in the way described above.

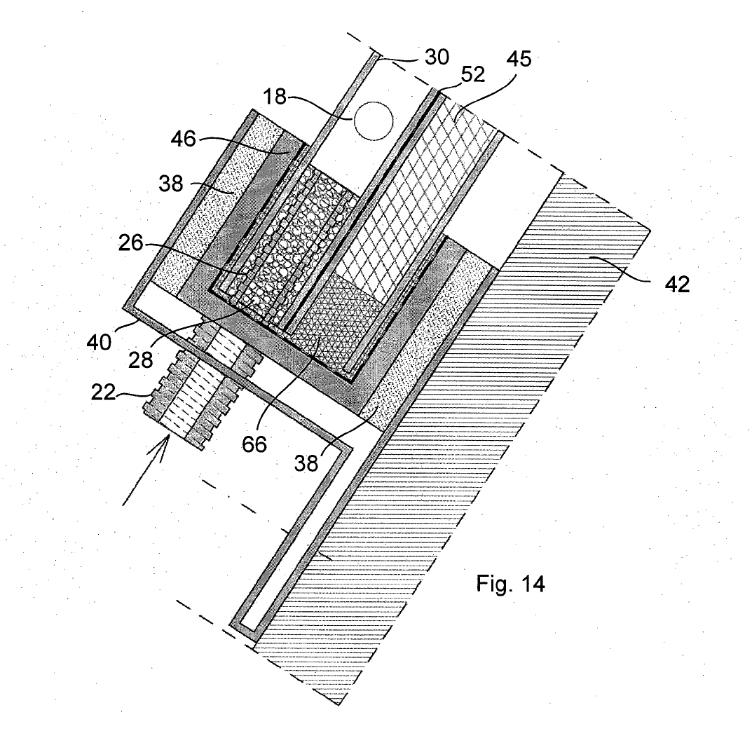

FIG. 14 shows the structure and installation method of the panel 10 depicted in FIG. 13C. The embodiment shown in the figure is also featured in FIG. 12, but this figure shows a cross-sectional view through the joint 32.

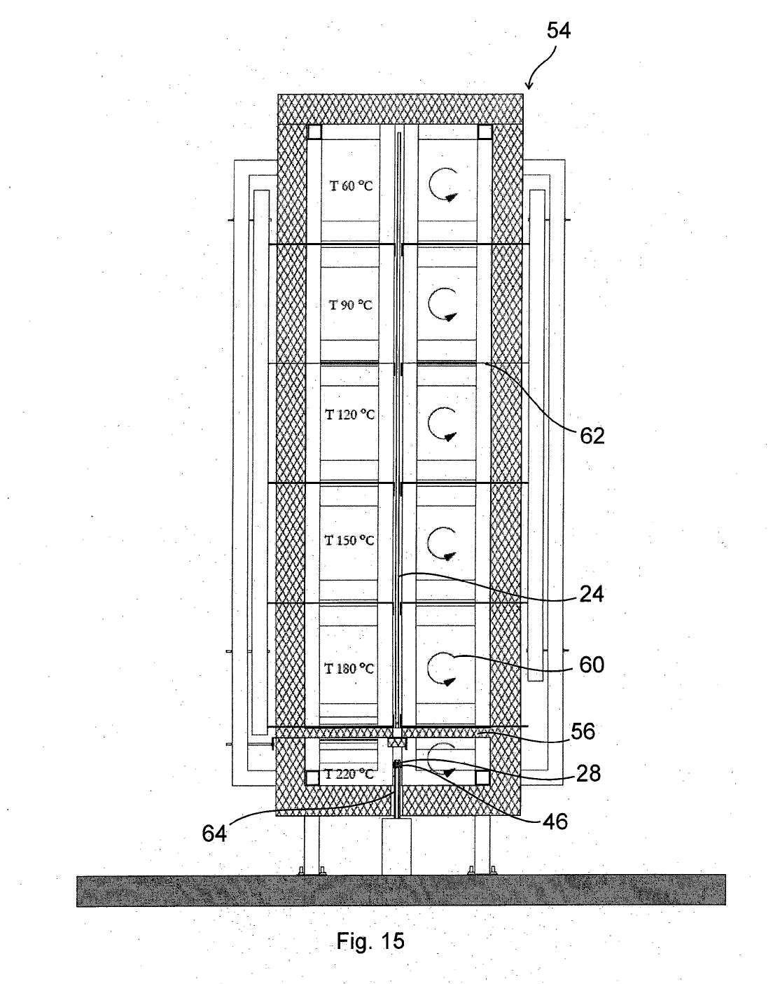

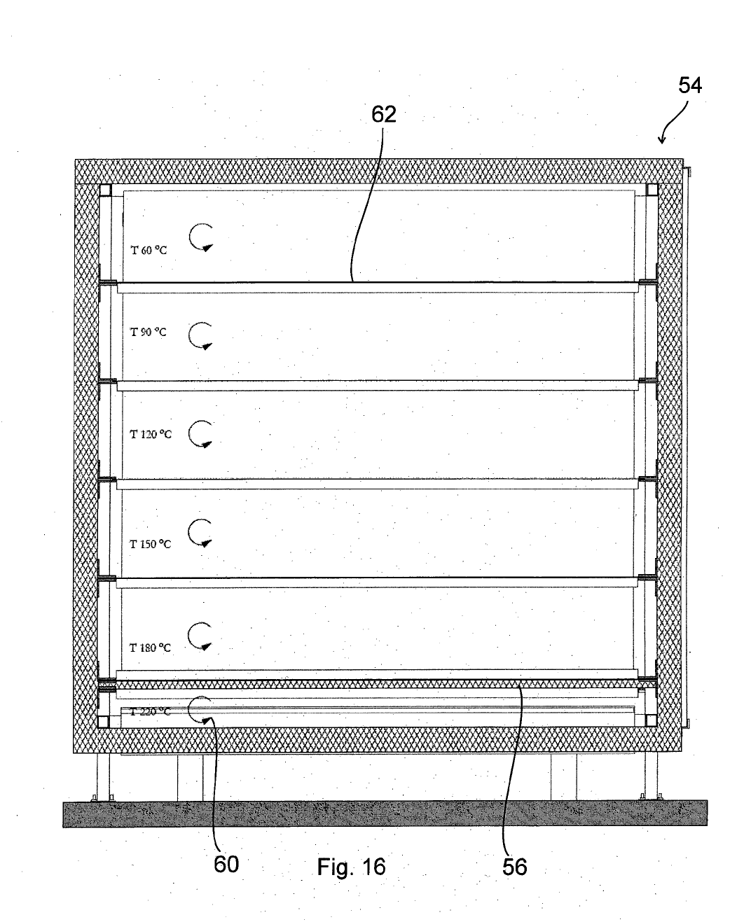

In the following, an apparatus will be described by way of example, which is designed to produce the heat exchanger panel 10 according to the invention, with the views taken along various sections of the apparatus are shown in FIGS. 15 and 16. This apparatus 54 is suitable for sealing the applied polycarbonate board 24 with a polycarbonate sealant 28. The apparatus 54 must meet a number of requirements, and in the course of manufacturing the heat exchanger panel 10 according to the invention, the most important requirements are the following:
1. The temperature difference between the polycarbonate sealant 28 used as a sealant and the board 24 must be minimised at the time of assembly.
2. Identical temperature must be provided everywhere in the heating space containing the board end to be sealed and the polycarbonate granulate sealant 28 prepared in the U-shaped tool 46. This can be achieved by appropriate thermal insulation and intensive air agitation in the heating spaces; the air agitation direction 60 is shown in FIGS. 15 and 16.
3. When pressing in the board 24, because of the substantial longitudinal dimensions of the board, not even a minimal angular difference is allowed between the board 24 and the U-shaped tool 46.
4. Due to the oxidation of the surface of the polycarbonate sealant 28, it is necessary to apply a shielding gas (CO₂, N₂).
5. For a more uniform distribution of stress, it is necessary to pre-heat the longer part of the board 24 gradually, to a decreasing extent moving away from the end to be sealed.
6. The temperature of the polycarbonate sealant 28 in the U-shaped tool 46 and that of the heated up board 24, primarily their external surfaces, drop by several tens of degrees even in a few seconds at room temperature, and therefore the possibility of undesired cooling must be avoided, i.e. the assembly of the polycarbonate sealant 28 in the U-shaped tool 46 and the board 24 must be carried out in the space intended for the heating up of the board 24.

The apparatus 54 consists of two thermal insulated spaces separated from each other by the thermal insulated wall 56, controlled by a separate thermostat, fitted with electric heating and on the external side with a rockwool sandwich panel. The heating up of the polycarbonate sealant 28 filled as a granulate into the U-shaped tool 46 to a temperature necessary for assembly takes place in the lower space, and the board 24 is preheated in the upper space. The board 24 is inserted from the side, and fixing after appropriate positioning is provided by two pairs of large surface clamping jaws (not shown) arranged on the top of the apparatus 54 and actuated by hydraulic cylinder. The clamping jaws hold the board 24 at an appropriate height during heat-up and prevent the displacement of the board 24 upwards during the assembly. In the upper space, the rail-mounted, movable and fixable steel plate pairs 62 are pressed against the board 24 by springs, and they on the one hand ensure the vertical position of the inserted board 24, and on the other prevent lateral buckling and a circulation in the complete inner space, which would lead to an unfavourable homogeneous temperature distribution. Depending on the number of steel plates 62, a tiered temperature distribution evolves in the upper space, and therefore the temperature of the board 24 decreases gradually from the bottom to the top.

Below the structure 64 positioning the U-shaped tool 46 in the lower space, there are two hydraulic cylinders. Assembly is carried out in a way that the thermal insulated partition plate between the two spaces is shifted laterally, and then on a sufficiently rigid support the two lower work cylinders lift to a predetermined height the U-shaped tool 46 containing the polycarbonate sealant 28, and therefore the board 24 secured in a vertical position in the pre-heating space above is pressed into the said sealant.

After assembly, as a result of switching off the heating and/or applying ventilation, the temperature begins to decrease in both spaces of the apparatus 54. If the temperature of the system decreases to below 150° C., the board 24 can be removed in a lateral direction from the apparatus 54 and further cooling can take place at room temperature. After cooling off, together with the installed joint 22, the U-shaped tool 46 optionally remaining on the end of the board 24 also provides the mechanical protection of the sealing unit 16.

The boards 24 prepared for creating the sealing unit 16 and the filled up U-shaped tools 46 can be stored separately as a preparation for assembly in the pre-heating space, which is at a 20° C. lower temperature in each space as an example than the installation temperature, and therefore the apparatus 54 can be operated with a short cycle and high efficiency. The pre-heating system can be fully assembled with the apparatus 54.

The heat exchanger panel 10 made of the multilayer polycarbonate board 24 can be suitably applied in such architectural projects where multilayer polycarbonate boards are used anyway. In the architectural applications of such multilayer polycarbonate boards, the biggest problem is caused by the seasonal changes of weather in temperate climate zone. Inner spaces confined or covered by polycarbonate boards are pleasantly heated or further heated by the rays of the sun in wintertime in bright weather, but they are extremely overheated in the warmer half of the year, and this overheating can only be stopped by ventilation or air conditioning at an extremely high cost and frequently with an insufficient efficiency even after substantial investments. This is also true in the case of water parks, swimming pools, hobby and large-scale greenhouses, winter gardens, etc. Cooling entails a very substantial extra cost from an investment aspect and also in daily operations.

The significant annual fluctuations in sun radiation intensity and in the number of sunny hours result in very strong deviations in the quantity of solar energy reaching the earth daily in each month of the year. In Hungary, the number of sunny hours on a multi-year average is 275 hours in July, against 50 hours in December. The same trend as the number of sunny hours is exhibited by the distance between the Sun and the Earth and the apparent altitude of the Sun, i.e. the average daily angle of incidence of the radiation. All these impacts jointly result in the fact that the monthly solar energy potential measurable on the surface of the earth is 299 MJ/m² in December, but it is above 1000 MJ/m² from May to August and in June it reaches its peak rate of 1226 MJ/m². The sun radiation increasing in summer causes substantial overheating in buildings, especially because of the high external temperatures which entail cooling requirements anyway.

The fluid cooled multilayer polycarbonate board, i.e. the heat exchanger panel 10 offers an excellent solution for this problem. If the temperature of the inner space confined by the heat exchanger panels 10 does not reach the necessary level, then there is air in the channels 14 of the panels 10. When reaching a pre-set temperature limit, the filling up of the heat exchanger panel 10 with a heat exchanger medium can be initiated, preferably by automation. The heat exchanger medium is preferably water, a fluid with an antifreeze additive or in the case of other applications a dark coloured fluid or an arbitrary combination of two or more of these materials, for example a mixture of water and ethylene glycol or a CaCl₂ salt solution. In the filled up panel 10, the primary absorption of the infrared part of the solar energy takes place almost fully in any case, i.e. nearly 50% of the energy arriving to the surface of the panel 10 is absorbed in the heat exchanger medium, as a result of which the heat exchanger medium is heated up. The flow rate and hence the quantity of energy absorbed by the medium flowing through the heat exchanger panel 10, and the temperature of the heat exchanger medium, respectively, and therefore the quantity of energy radiated from the heated up medium into the inner space on the inner space side of the panel 10 can be regulated by adjustment to the temperature of the inner space. The heated up medium can be cooled down without any further invested energy in heat exchangers placed in a shady place outside the building or it is suitable for producing domestic hot water in some inner heat exchangers, either directly or as the primary side of heat pumps.

Using a multi-layer polycarbonate board periodically filled up with fluid instead of boards containing air or such subsequent conversion of boards already installed does not interfere in the slightest way with the original illumination function, because visible light passes practically without any loss through the water layer of 8 to 20 mm thickness.

Filling up subsequently with heat exchanger medium the multilayer polycarbonate boards fitted earlier, i.e. exchanging the installed boards with or converting to the heat exchanger panels 10 does not present a static problem in the already existing buildings, because during the original installation, even the structure of empty boards is dimensioned for a 40 cm snow load, which is a much higher burden than that caused by a fluid layer of 8 to 22 mm thickness.

Therefore, the heat exchanger panel 10 can be used advantageously as a covering which prevents the overheating of inner spaces and reduces the subsequent cooling and ventilation requirements, for example in swimming pools, water parks, sports halls and passive houses. In addition, this solution is useful in the case of all building types confined by multilayer polycarbonate surfaces. The heat exchanger panel 10 can be used advantageously as the covering for greenhouses, especially and preferably as the covering for compact, ready to use coolable large-scale or even small garden greenhouses, because one of the biggest problems of growing plants in greenhouses in temperate climate zones is overheating, and in the case of most cultivated plants, the low relative humidity due to intensive ventilation is also a cause for concern. The heat exchanger panel 10 is excellent for handling this disadvantage, similarly to the examples detailed above.

The various steps of the manufacturing method of the heat exchanger panel 10 have been presented above. In the course of the procedure providing a board having plates 30 parallel to each other, and partition walls dividing the inner space between the plates 30 into parallel channels 14 is, said partition walls join the plates 30 and made of the same material as the plates. This board 24 is preferably made of transparent plastic. The board 24 applied in the course of the procedure is especially preferably the pre-manufactured polycarbonate board 24 described above. In the partition walls 12, passages 18 are created with an appropriate puncturing tool to enable the flow of medium between the neighbouring channels 14, and to provide a flow path 20 for the heat exchanger medium, and joints 22 are provided allowing the heat exchanger medium to enter into and exit from the panel 10. After this, the sealing units 16 covering the ends of the channels 14 are made in a way that a sealant being thermal expansion compatible with the board 24, is introduced into the ends of the channels 14.

During the procedure, the sealing units 16 preferably may also be created with plugs 36. In this case, the sealing units 16 can be made preferably of flexible, preferably rubber or silicone truncated pyramid shape plugs, which have preferably a receiving blind hole 48, and at the inner ends thereof they are reinforced with a pressure distributing metal insert 50, and furthermore advantageously two such plugs 36 are also inserted, which also comprises the joints 22 serving as the inlet and outlet of the heat exchanger medium.

In the course of the procedure, the sealing units 16 can be furthermore preferably made by introducing a PUR-based sealant 34 into the ends of the channels 14.

Especially preferably, the sealing units 16 can be made of the same material as the board 24. In the case of applying the polycarbonate board 24 this means that the sealing units 16 are also made of polycarbonate. When creating the sealing units 16, the sealant introduced into the ends of the channels 14 can be the same material of the board 24 also in a way that the sealing units 16 are made by melting the ends of the plates 30 to each other.

Furthermore, the sealing units 16 can be made by introducing a sealant in a plastic state into the ends of the channels 14, when the part of the material of the board 24 being in contact with the sealant is melted with the sealant thereby creating a material structure link between the board 24 and the sealant. Preferably, this sealant is introduced into the ends of the channels 14 by using an U-shaped tool 46 closed at the two ends and having a space for storing the sealant, or by using an extruder.

The sealing units 16 may also be reinforced by the installation of fibreglass 32, if the sealing units 16 are made of a polycarbonate sealant 28 or a PUR-based sealant 34. In this case, the joints 22, the connection pieces can be positioned into fixing points prior to the introduction of the sealant from which the sealing units 16 are made. In order to prevent the oxidation of the appropriate sealant, preferably a shielding gas can be applied during the procedure.

In the course of the procedure, preferably along at least one part of one of the plates 30 of the panel 10, a heat insulating material 44 can be arranged in a way so as to prevent aeration, and the surface of this plate 30 can be painted a light absorbing colour.

In the course of the procedure, preferably a board 24 having more than two plates 30 and accordingly comprising at least one further inner space can be applied, and the heat insulating material 45, and especially preferably polyurethane foam is introduced into the channels of the further inner space, in a way that the inner space is at least partially filled up.

In the course of the procedure, preferably along at least one part of one of the plates 30 of the panel 10, a dark surface heat insulating material 44 may be arranged, which can be inserted into a fixing piece 40 jointly with the heat exchanger panel 10.

Of course, the invention is not limited to the preferred embodiments presented in details, but further versions, modifications and further developments are possible within the scope defined by the following claims.

1. A heat exchanger panel (10), preferably for heat exchange utilizing light energy, comprising:
a board (24) having plates (30) parallel to each other, and partition walls (.12) dividing the inner space between the plates (30) into parallel channels (14), said partition walls (12) joining the plates (30) and being of a same material as the plates (30),
passages (18) in the partition walls (12), said passages 918) enabling a flow of a heat exchanger medium between the neighbouring channels (14) and providing a flow path (20) for the medium,
sealing units (16) covering openings at the ends of the channels (14) and
joints 922) allowing the heat exchanger medium to enter into and exit from the panel (10),
characterized in that
the sealing units (16) are made of a sealant (28, 34) introduced into the ends of the channels (14), said sealant (28, 34) being thermal expansion compatible with the material of the board (24).

2. The panel (10) according to claim 1, characterized in that the board (24) is made of a transparent thermoplastic material.

3. The panel (10) according to claim 1, characterized in that the sealing units (16) are formed as flexible material plugs (36) fitted into the ends of the channels (14).

4. The panel (10) according to claim 1, characterized in that the sealing units (16) are made of a polyurethane based sealant (34) injected into the ends of the channels (14).

5. The panel (10) according to claim 1, characterized in that the sealing units (16) are made of the same material as the board (24).

6. The panel (10) according to claim 2, characterized in that the board (24) is made of polycarbonate.

7. The Panel (10) according to claim 3, characterised in that the plugs (36) are made of rubber or silicon, said plugs (36) have a truncated pyramid shape, comprise a blind hole (48) facilitating insertion, and at the inner end are reinforced with a pressure distributing metal insert (50).

8. The panel (10) according to claim 1, characterised in that the sealing units (16) are reinforced with the fiberglass (32) fitted into the sealant (28, 34).

9. The panel (10) according to claim 1, characterised in that the passages (18) are made next to the scaling units (16), alternatively at the longitudinal ends of the partition walls (12) between the neighbouring channels (14) in a way so as to establish a serpentine type flow path (20).

10. The panel (10) according to claim 9, characterised in that the joints (22) are formed at each of the two ends of the serpentine type flow path (2), respectively.

11. The panel (10) according to, claim 1 characterised in that along at least a part of the external surface of one of the plates (30) a heat insulating material (44) is arranged in a way preventing aeration between the panel and the heat insulating layer.

12. The panel (10) according to claim 1, characterised in that the board (24) comprises more than two plates (30) and accordingly at least one further inner space, and a heat insulating material (45) is introduced into the channels (14) of this further inner space in a way filling up the further inner space at least partly, and at least one of the plates (30) bordering the said further inner space is dark coloured (52).

13. The panel (10) according to claim 1, characterised in that by comprising a further two-layer board (24) having a side facing the board (24) for the heat exchanger medium, the side having a dark colouring (52), and the channels (14) of the further two-layer board (24) are filled up with a heat insulating material (45), and the two boards (24) are attached to each other in a common polycarbonate U-shaped tool (46) embedded in a PUR-based sealant (66).

14. The panel (10) according to claim 12, characterised in that the heat insulating material (45) is a polyurethane foam curing after installation in the channels (14).

15. The panel (10) according to claim 1, characterised in that the heat exchanger medium is water, a dark coloured fluid, a fluid with an antifreeze additive, or two or more combination of these materials, for example the mixture of water and ethylene-glycol and CaCl₂ salt solution.

16. The application of the panel (10) according to claim 1, as a coverage preventing overheating of inner spaces and reducing their ventilation requirement, for example in swimming pools, water parks, sports halls and passive houses.

17. The application of the panel (10) according to claim 1 as a covering of a greenhouse, preferably as the covering of a compact ready to use coolable greenhouse.

18. A method for manufacturing a heat exchanger panel (10), comprising the steps of:
providing a board (24) having plates (30) parallel to each other, and partition walls (12) dividing the inner space between the plates (30) into parallel channels (14), said partition wails (12) joining the plates (30) and being of a same material as the plates (30),
forming passages (18) in the partition walls (12), said passages (18) enabling a flow of a heat exchanger medium between the neighbouring channels (14), and providing a flow path (20) for the medium, and
installing joints (22) allowing the heat exchanger medium to enter into and exit from the panel (10),
characterised by the further step of
forming sealing units (16) covering the ends of the channels (14) by introducing a sealant (28, 34) into the ends of the channels (14), the sealant (28, 34) being thermal expansion compatible with the material of the board (24).

19. The method according to claim 18, characterised in that a board (24) made of transparent plastic is used.

20. The method according to claim 18, characterised in that the sealing units (16) are formed with plugs (36).

21. The method according to claim 20, characterised in that flexible, preferably rubber or silicone based truncated pyramid shape plugs (36) are applied for the sealing units (16), said plugs preferably having a receiving blind hole (48) and at the inner end a pressure distributing metal inert (50) is used for reinforcement, and furthermore two plugs (36) also comprising the joints (22) serving as the inlet and outlet of the heat exchanger medium are inserted.

22. The method according, to claim 18, characterised in that the sealing units (16) are made by introducing a polyurethane based sealant (34) into the ends of the channels (14).

23. The method according to claim 18, characterised in that the sealing units (16) are made of the same materials as the board (24).

24. The method according to claim 19, characterised in that a polycarbonate board (24) is applied.

25. The method according to claim 18, characterised by creating the sealing units (16) in a way that the sealant introduced into the ends of the channels (14) is the own material of the board (24), and that the sealing units (16) are made by melting the ends of the plates (30) to each other.

26. The method according to claim 18, characterised in that the sealing units (16) are made by introducing a sealant (28) in plastic state into the ends of the channels (14), and the part of the material of the board (24) being in contact with the sealant (28) is melted with the sealant (28), thereby creating a material bound between the board (24) and the sealant (28).

27. The method according to claim 26, characterised in that the sealant (28) is introduced into the ends of the channels (14) by means of a longitudinal U-shaped tool (46) closed at the two ends and having a space for storing the sealant, or by using an extruder.

28. The method according to claim 22, characterised in that the sealing units (16) are reinforced with a fiberglass (32) insert.

29. The method according to claim 25, characterised in that the joints (22) are connection pieces, which are positioned into fixing positions prior to the introduction of the sealant (28, 34) of the sealing units (16).

30. The method according to claim 25, characterised by avoiding the oxidation of the sealant (28, 34) by applying a shielding gas during the method.

31. The method according to claim 18, characterised in that along at least one part of one of the plates (30) a heat a heat insulating material (44) is arranged in a way preventing aeration, and at least one surface of the plate (30) is painted a dark, preferably black colour.

32. The method according to claim 18, characterised in that a board (24) having more than two plates (30) and accordingly comprising at least one further inner space is applied, and a heat insulating material (45) preferably a polyurethane foam is introduced into the channels (14) of the further inner space in a way that the further inner space is at least partially filled up.

33. The method according to claim 18, characterised in that along at least one part of one of its plates (30) a dark surface heat insulating material (44) is arranged, which is inserted into a fixing piece (40) jointly with the heat exchanger panel (10).

34. The method according to claim 18, characterised in that the panel (10) includes two boards (24) and one of the boards (24) has a dark colouring (52) and its channels (14) are filled up with a heat insulating material (45), and the two boards (24) are fixed by pressing into a PUR-based sealant (66) in a common polycarbonate U-shaped tool (46).
